(19) United States
(12) Patent Application Publication
(10) Pub. No.: US 2011/0216791 A1
(43) Pub. Date: Sep. 8, 2011

(54) PHASE CONTROL DEVICE FOR LASER LIGHT PULSE

(75) Inventor: Tomoyu YAMASHITA, Miyagi (JP)

(73) Assignee: ADVANTEST Corporation, Tokyo (JP)

(21) Appl. No.: 12/960,841

(22) Filed: Dec. 6, 2010

(30) Foreign Application Priority Data
Mar. 8, 2010 (JP) 2010-050658

(51) Int. Cl. H01S 3/13

(52) U.S. Cl. 372/29.016

(57) ABSTRACT

According to the present inventions, a phase control device for laser light pulse includes a laser, a reference comparator, a measurement comparator, a phase difference detector and a loop filter. The laser outputs a laser light pulse. The reference comparator compares a voltage of a reference electric signal having a predetermined frequency and a predetermined voltage with each other, thereby outputting a result thereof. The measurement comparator compares a voltage based on a light intensity of the laser light pulse and a voltage of a measurement electric signal having the predetermined frequency, with a voltage of a phase control signal, thereby outputting a result thereof. The phase difference detector detects a phase difference between the output from the reference comparator and the output from the measurement comparator. The loop filter removes a high frequency component of an output from the phase difference detector. Further, the voltage of the phase control signal is different from the predetermined voltage. Furthermore, the laser changes the phase of the laser light pulse according to the output from the loop filter.

### BACKGROUND ART

1. Field of the Invention

The present invention relates to control of the phase of a laser light pulse.

2. Description of the Prior Art

It has conventionally been known that a phase difference between light pulses output from two lasers is detected, and the phase of the light pulse output from either one of the two lasers is controlled based on the detection result (refer to FIG. 13 of a patent document 1 (Japanese Laid-Open Patent Publication (Kokai) No. H10-96610) and FIG. 2 of a patent document 2 (German Utility Model No. 202008009021), for example).

### SUMMARY OF THE INVENTION

An object of the present invention is to control the phase of a light pulse output from a laser without depending on a result of detection of a phase difference between light pulses output from two lasers.

According to the present invention, a first phase control device for laser light pulse includes: a laser that outputs a laser light pulse; a reference comparator that compares a voltage of a reference electric signal having a predetermined frequency and a predetermined voltage with each other, thereby outputting a result thereof; a measurement comparator that compares a voltage based on a light intensity of the laser light pulse and a voltage of a measurement electric signal having the predetermined frequency, with a voltage of a phase control signal, thereby outputting a result thereof; a phase difference detector that detects a phase difference between the output from the reference comparator and the output from the measurement comparator; and a loop filter that removes a high frequency component of an output from the phase difference detector, wherein: the voltage of the phase control signal is different from the predetermined voltage; and the laser changes the phase of the laser light pulse according to the output from the loop filter.

According to the thus constructed first phase control device for laser light pulse, a laser outputs a laser light pulse. A reference comparator compares a voltage of a reference electric signal having a predetermined frequency and a predetermined voltage with each other, thereby outputting a result thereof. A measurement comparator compares a voltage based on a light intensity of the laser light pulse and a voltage of a measurement electric signal having the predetermined frequency, with a voltage of a phase control signal, thereby outputting a result thereof. A phase difference detector detects a phase difference between the output from the reference comparator and the output from the measurement comparator. A loop filter removes a high frequency component of an output from the phase difference detector. Further, the voltage of the phase control signal is different from the predetermined voltage. Furthermore, the laser changes the phase of the laser light pulse according to the output from the loop filter.

According to the first phase control device for laser light pulse of the present invention, the predetermined voltage may be a ground electric potential.

According to the first phase control device for laser light pulse of the present invention, a resonator length of the laser may change according to the output from the loop filter.

According to the first phase control device for laser light pulse of the present invention, the laser may include a piezo element; the output from the loop filter may be fed to the piezo element; and the resonator length of the laser may be changed by extension and contraction of the piezo element.

According to the present invention, the first phase control device for laser light pulse may include a photoelectric conversion unit that receives the laser light pulse; and a low-pass filter that removes a high frequency component of the output from the photoelectric conversion unit, wherein the measurement electric signal may be based on the output from the low-pass filter.

According to the first phase control device for laser light pulse of the present invention, the phase control signal may be output from an arbitrary waveform generator.

According to the present invention, the first phase control device for laser light pulse may further include: a reference laser that outputs a reference laser light pulse; a reference photoelectric conversion unit that receives the reference laser light pulse; and a reference low-pass filter that removes a high frequency component of the output from the reference photoelectric conversion unit, wherein the reference electric signal may be based on the output from the reference low-pass filter.

According to the present invention, a second phase control device for laser light pulse may include; a laser that outputs a laser light pulse; a reference comparator that compares a voltage of a reference electric signal having a predetermined frequency and a predetermined voltage with each other, thereby outputting a result thereof; a measurement comparator that compares a voltage based on a light intensity of the laser light pulse and a voltage of a measurement electric signal having the predetermined frequency; with the predetermined voltage, thereby outputting a result thereof; a phase difference detector that detects a phase difference between the output from the reference comparator and the output from the measurement comparator; a loop filter that removes a high frequency component of an output from the phase difference detector, wherein: the voltage of the measurement electric signal is changed; and the laser changes the phase of the laser light pulse according to the output from the loop filter.

According to the thus constructed second phase control device for laser light pulse, a laser outputs a laser light pulse. A reference comparator compares a voltage of a reference electric signal having a predetermined frequency and a predetermined voltage with each other, thereby outputting a result thereof. A measurement comparator compares a voltage based on a light intensity of the laser light pulse and a voltage of a measurement electric signal having the predetermined frequency, with the predetermined voltage, thereby outputting a result thereof. A phase difference detector detects a phase difference between the output from the reference comparator and the output from the measurement comparator. A loop filter removes a high frequency component of an output from the phase difference detector. The voltage of the measurement electric signal is changed; and the laser changes the phase of the laser light pulse according to the output from the loop filter.

According to the second phase control device for laser light pulse of the present invention, the voltage of the measurement electric signal may be changed by changing a power of excitation light exciting the laser.

According to the second phase control device for laser light pulse of the present invention, the voltage of the measurement electric signal may be changed by attenuating the laser light pulse; and the degree of the attenuation may be variable.

According to the second phase control device for laser light pulse of the present invention, the predetermined voltage may be a ground electric potential.

According to the second phase control device for laser light pulse of the present invention, a resonator length of the laser may change according to the output from the loop filter.

According to the second phase control device for laser light pulse of the present invention, the laser may include a piezo element; the output from the loop filter may be fed to the piezo element; and the resonator length of the laser may be changed by extension and contraction of the piezo element.

According to the present invention, the second phase control device for laser light pulse may include: a photoelectric conversion unit that receives the laser light pulse; and a low-pass filter that removes a high frequency component of the output from the photoelectric conversion unit, wherein the measurement electric signal is based on the output from the low-pass filter.

According to the second phase control device for laser light pulse of the present invention, the voltage of the measurement electric signal may change based on a phase control signal; and the phase control signal may be output from an arbitrary waveform generator.

According to the present invention, a third phase control device for laser light pulse includes: a laser that outputs a laser light pulse; a reference comparator that compares a voltage of a reference electric signal having a predetermined frequency and a voltage of a phase control signal, with each other, thereby outputting a result thereof, a measurement comparator that compares a voltage based on a light intensity of the laser light pulse and a voltage of a measurement electric signal having the predetermined frequency, with a predetermined voltage, thereby outputting a result thereof; a phase difference detector that detects a phase difference between an output from the reference comparator and the output from the measurement comparator; a loop filter that removes a high frequency component of an output from the phase difference detector, wherein: the voltage of the phase control signal is different from the predetermined voltage; and the laser changes the phase of the laser light pulse according to the output from the loop filter.

According to the thus constructed third phase control device for laser light pulse, a laser outputs a laser light pulse. A reference comparator compares a voltage of a reference electric signal having a predetermined frequency and a voltage of a phase control signal with each other, thereby outputting a result thereof. A measurement comparator compares a voltage based on a light intensity of the laser light pulse and a voltage of a measurement electric signal having the predetermined frequency, with a predetermined voltage, thereby outputting a result thereof. A phase difference detector detects a phase difference between an output from the reference comparator and the output from the measurement comparator. A loop filter removes a high frequency component of an output from the phase difference detector. Further, the voltage of the phase control signal is different from the predetermined voltage. Furthermore, the laser changes the phase of the laser light pulse according to the output from the loop filter.

According to the third phase control device for laser light pulse of the present invention, the predetermined voltage may be a ground electric potential.

According to the third phase control device for laser light pulse of the present invention, a resonator length of the laser may change according to the output from the loop filter.

According to the third phase control device for laser light pulse of the present invention, the laser may include a piezo element; the output from the loop filter may be fed to the piezo element; and the resonator length of the laser may be changed by extension and contraction of the piezo element.

According to the present invention, the third phase control device for laser light pulse may include: a photoelectric conversion unit that receives the laser light pulse; and a low-pass filter that removes a high frequency component of the output from the photoelectric conversion unit, wherein the measurement electric signal may be based on the output from the low-pass filter.

According to the third phase control device for laser light pulse of the present invention, the phase control signal may be output from an arbitrary waveform generator.

### BRIEF DESCRIPTION OF THE DRAWINGS

FIG. 1 is a functional block diagram showing a configuration of a phase control device for laser light pulse 1 according to a first embodiment of the present invention;

FIG. 2 shows a waveform of an output voltage of a reference comparator 22 (FIG. 2(a)), a waveform of an output voltage of a measurement comparator 15 (before phase fluctuation) (FIG. 2(b)), and a waveform of an output voltage of an amplifier 18 (after phase fluctuation) (FIG. 2(c)) according to the first embodiment;

FIG. 3 is a functional block diagram showing a configuration of the phase control device for laser light pulse 1 according to the variation of the first embodiment of the present invention;

FIG. 4 is a functional block diagram showing a configuration of the phase control device for laser light pulse 1 according to the second embodiment of the present invention;

FIG. 5 shows a waveform of an output voltage of the reference comparator 22 (FIG. 5(a)), a waveform of an output voltage of the measurement comparator 15 (before phase fluctuation) (FIG. 5(b)), and a waveform of an output voltage of the amplifier 18 (after phase fluctuation) (FIG. 5(c)) according to the second embodiment;

FIG. 6 is a functional block diagram showing a configuration of the phase control device for laser light pulse 1 according to the variation of the second embodiment of the present invention;

FIG. 7 is a functional block diagram showing a configuration of the phase control device for laser light pulse 1 according to the third embodiment of the present invention; and

FIG. 8 shows a waveform of an output voltage of the reference comparator 22 (FIG. 8(a)), a waveform of an output voltage of the measurement comparator 15 (before phase fluctuation) (FIG. 8(b)), and a waveform of an output voltage of the amplifier 18 (after phase fluctuation) (FIG. 8(c)) according to the third embodiment.

### BEST MODE FOR CARRYING OUT THE INVENTION

A description will now be given of embodiments of the present invention referring to drawings.

### First Embodiment

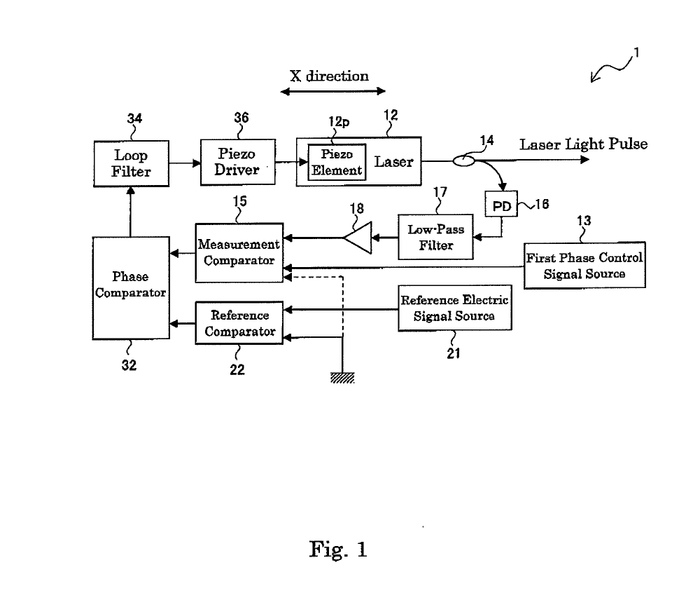

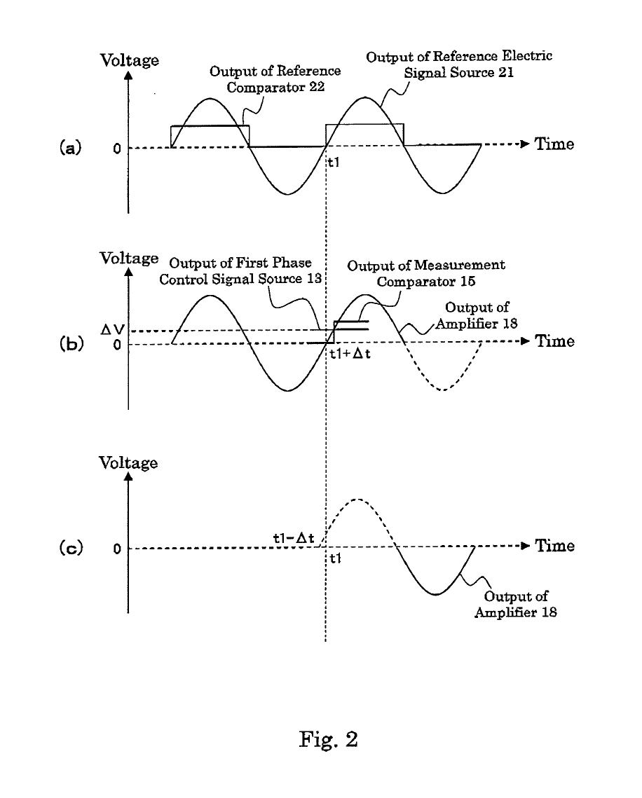

FIG. 1 is a functional block diagram showing a configuration of a phase control device for laser light pulse 1 according to a first embodiment of the present invention. FIG. 2 shows a waveform of an output voltage of a reference comparator 22 (FIG. 2(a)), a waveform of an output voltage of a measurement comparator 15 (before phase fluctuation) (FIG. 2(b)), and a waveform of an output voltage of an amplifier 18 (after phase fluctuation) (FIG. 2(c)) according to the first embodiment.

The phase control device for laser light pulse 1 according to the first embodiment includes a laser 12, a first phase control signal source 13, an optical coupler 14, the measurement comparator 15, a photodiode (photoelectric conversion unit) 16, a low-pass filter 17, the amplifier 18, a reference electric signal source 21, the reference comparator 22, a phase comparator (phase difference detector) 32, a loop filter 34, and a piezo driver 36.

The laser 12 outputs a laser light pulse. It should be noted that the repetition frequency of the laser light pulse is approximately the same as the frequency (such as 50 MHz) of a reference electric signal output from the reference electric signal source 21.

The laser 12 includes a piezo element 12p. The piezo element 12p extends and contracts in an X direction (horizontal direction in FIG. 1) as a result of application of a voltage of an output from the loop filter 34 after amplification by the piezo driver 36. The extension/contraction in the X direction of the piezo element 12 changes a laser resonator length of the laser 12. The change in the laser resonator length changes the repetition frequency of the laser light pulse, thereby changing the phase of the laser light pulse.

The optical coupler 14 receives the laser light pulse output from the laser 12, and outputs the laser light pulse to a photodiode 16 and the outside at a ratio of 1:9 as a power ratio, for example. For example, the optical power of the laser light pulse fed to the photodiode 16 is 10% of the optical power of the laser light pulse output from the laser 12.

The photodiode (photoelectric conversion unit) 16 receives the laser light pulse from the optical coupler 14, and converts the laser light pulse into an electric signal. The repetition frequency of the laser light pulse is approximately 50 MHz. Moreover, a fluctuation of the repetition frequency caused by the extension/contraction of the piezo element 12p is minute, and the repetition frequency of the laser light pulse can thus be considered as 50 MHz. As a result, the electric signal has a component of the frequency 50 MHz (component of the frequency of the reference electric signal), and a high-frequency component (frequency is much higher than 50 MHz).

The low-pass filter 17 removes the high-frequency component of the output from the photodiode 16. The cutoff frequency of the low-pass filter 17 is 70 MHz, for example. Thus, when the low-pass filter 17 receives the output from the photodiode 16, the high-frequency component is removed, and the component of the frequency 50 MHz (component of the frequency of the reference electric signal) passes. It should be noted that “removal” does not necessarily implies a complete removal, and includes a case in which a slight amount of the high-frequency component is left. “Removal” in a subsequent section has the same connotation.

The amplifier 18 amplifies the output from the low-pass filter 17. The output from the amplifier 18 is referred to as measurement electric signal. Obtaining the measurement electric signal corresponds to a measurement of the light intensity of the laser light pulse.

The measurement electric signal is obtained by amplifying the output from the photodiode 16 by the amplifier 18, and thus has a voltage based on the light intensity of the laser light pulse. Moreover, the measurement electric signal has passed through the low-pass filter 17, and thus has the predetermined frequency (frequency of the reference electric signal).

It is conceivable to switch the low-pass filter 17 and the amplifier 18 with each other, and to feed the output from the photodiode 16 via the amplifier 18 to the low-pass filter 17. In this case, the measurement electric signal is the output from the low-pass filter 17. In either case, the measurement electric signal remains the signal based on the output from the low-pass filter 17.

The reference electric signal source 21 outputs the reference electric signal having the predetermined frequency (50 MHz, for example).

The reference comparator 22 compares the voltage of the reference electric signal and the predetermined voltage with each other, thereby outputting a result thereof. It should be noted that the predetermined voltage is a ground electric potential, for example. Referring to FIG. 1, out of two input terminals of the reference comparator 22, one is connected to the output from the reference electric signal source 21, and the other is grounded. The signal output from the reference comparator 22 is determined according to the magnitude of the voltage input to the two input terminals of the reference comparator 22.

For example, referring to FIG. 2(a), if the voltage of the output from the reference electric signal source 21 is greater than the ground electric potential (=0[V]), the voltage of the signal output from the reference comparator 22 is a predetermined positive value. If the voltage of the output from the reference electric signal source 21 is less than or equal to the ground electric potential (=0[V]), the voltage of the signal output from the reference comparator 22 is 0[V].

The first phase control signal source 13 outputs the phase control signal. The voltage of the phase control signal is different from the predetermined voltage (ground electric potential). For example, referring to a neighborhood of a time t1+Δt in FIG. 2(b), the voltage ΔV of the phase control signal is different from the ground electric potential 0[V]. It should be noted that the first phase control signal source 13 is an arbitrary waveform generator, for example. For example, the phase control signal may have the voltage ΔV at the time t1+Δt, and a voltage 2 ΔV at a time t1+2 ΔV, by causing the arbitrary waveform generator to generate the phase control signal. Moreover, though ΔV>0 in FIG. 2(b), ΔV<0 may hold. In this case, Δt<0.

The measurement comparator 15 compares the voltage of the measurement electric signal and the voltage of the phase control signal with each other, thereby outputting a result thereof. In other words, the measurement comparator 15 receives the output from the amplifier 18 and the output from the first phase control signal source 13, compares both of them with each other, and outputs the result thereof.

For example, referring to the neighborhood of the time t1+Δt in FIG. 2(b), if the voltage of the output from the amplifier 18 is greater than the voltage ΔV of the output from the first phase control signal source 13, the voltage of the signal output from the measurement comparator 15 is a predetermined positive value. If the voltage of the output from the amplifier 18 is less than or equal to the voltage ΔV of the output from the first phase control signal source 13, the voltage of the signal output from the measurement comparator 15 is 0[V].

The phase comparator (phase difference detector) 32 detects and outputs the phase difference between the output from the reference comparator 22 and the output from the measurement comparator 15.

The loop filter 34 removes a high-frequency component of the output from the phase comparator 32.

The piezo driver 36 is a power amplifier, for example, and amplifies the output from the loop filter 34. The output from the piezo driver 36 is fed to the piezo element 12p. As a result, the piezo element 12p extends/contracts in the X direction. It should be noted that the piezo element 12p is caused to extend/contract so that the phase difference detected by the phase comparator 32 has a constant value (0 degree, 90 degrees, or −90 degrees, for example). As a result, the repetition frequency of the laser light pulse can precisely coincide with the frequency of the reference electric signal (50 MHz, for example).

A description will now be given of an operation of the first embodiment.

Referring to FIG. 2(a), the reference electric signal having the predetermined frequency (50 MHz, for example) is output from the reference electric signal source 21. Moreover, the comparison result between the voltage of the reference electric signal and the ground electric potential (=0[V]) is output from the reference comparator 22. As a result, the pulse having the repetition frequency 50 MHz is output from the reference comparator 22. On this occasion, it is assumed that the rise time of a certain pulse output from the reference comparator 22 is t1.

On this occasion, it is assumed that one input terminal of the measurement comparator 15 is not connected to the output from the first phase control signal source 13, but is grounded (refer to a dotted arrow directing to the measurement comparator 15 in FIG. 1) before the time t1+Δt. It should be noted that the other input terminal of the measurement comparator 15 is connected to the amplifier 18.

In this case, the operation of the phase control device for laser light pulse 1 is similar to that of an ordinary PLL circuit. In other words, the repetition frequency of the laser light pulse is 50 MHz (refer to the output from the amplifier 18 in FIG. 2(b)).

In more detail, referring to FIG. 1, the laser light pulse output from the laser 12 is partially led to the photodiode 16 by the optical coupler 14, undergoes the photoelectric conversion, and passes through the low-pass filter 17, resulting in the removal of the high frequency component. The output from the low-pass filter 17 is further amplified by the amplifier 18, and is compared by the measurement comparator 15 with the voltage of the phase control signal, which is equal to ground electric potential (=0[V]).

The phase comparator 32 compares the phase of the output from the measurement comparator 15 and the output from the reference comparator 22, and detects and outputs the phase difference therebetween. The high frequency component is removed from the output from the phase comparator 32 by the loop filter 34, and the resulting output is amplified by the piezo driver 36, and is fed to the piezo element 12p. The piezo element 12p extends/contracts so that the phase difference detected by the phase comparator 32 has a constant value (0 degree, 90 degrees, or −90 degrees, for example). As a result, the repetition frequency of the laser light pulse can precisely coincide with the frequency 50 MHz of the reference electric signal.

FIG. 2(b) shows a case in which the control is provided so that the phase difference detected by the phase comparator 32 is 0 degree. The last quarter period of the output from the amplifier 18 represented by a dotted line shows that the output waveform of the amplifier 18 will actually be deviated from the position indicated by the dotted line when the time reaches the corresponding time, which corresponds to the dotted line. It is assumed that the output waveform of the amplifier 18 shifts after approximately the quarter period (frequency 50 MHz) from the time t1+Δt in FIG. 2(b). The shift of the output waveform of the amplifier 18 after approximately the quarter period is simply an example, and the output waveform of the amplifier 18 may shift after a shorter or longer period than that.

Further, referring to FIG. 2(b), it is assumed that the one input terminal of the measurement comparator 15 is no longer grounded in the neighborhood of the time t1+Δt, and the phase control signal (voltage ΔV (>0[V])) output from the first phase control signal source 13 is fed to the one input terminal of the measurement comparator 15. Then, the rise time of the pulse output from the measurement comparator 15 is t1+Δt. As a result, a difference between the rise time t1 of the pulse output from the reference comparator 22 and the rise time t1+Δt of the pulse output from the measurement comparator 15 is generated.

Control is provided so that the phase difference detected by the phase comparator 32 is zero degree in this case as well. In other words, the output waveform of the amplifier 18 is controlled to be shifted leftward by Δt so that the pulse output from the measurement comparator 15 is shifted leftward by Δt.

FIG. 2(c) shows the output waveform of the amplifier 18 when the output waveform of the amplifier 18 is shifted by αt leftward. The first quarter period of the output from the amplifier 18 represented by a dotted line shows that the output waveform of the amplifier 18 has not completely been shifted at a time corresponding to the dotted line. In other words, the dotted line of the first quarter period of the output from the amplifier 18 is a virtual waveform obtained by extending, to the time t1−Δt, a waveform at a time when the output waveform of the amplifier 18 has completely shifted leftward by Δt.

Referring to FIGS. 2(b) and 2(c), it is appreciated that the phase of the output waveform of the amplifier 18 is shifted by Δt/T in a period approximately T/4 (it should be noted that T denotes the period of the output waveform of the amplifier 18). Therefore, it is appreciated that the phase of the laser light pulse shifts by Δt/T in a period approximately T/4.

According to the first embodiment, it is possible to control the phase of the laser light pulse output from the laser 12 without depending on a result of detection of a phase difference between light pulses output from two lasers.

The description is given while assuming that the reference electric signal source 21 outputs the reference electric signal according to the first embodiment. However, other configurations for outputting the reference electric signal are present, and are described as a variation of the first embodiment.

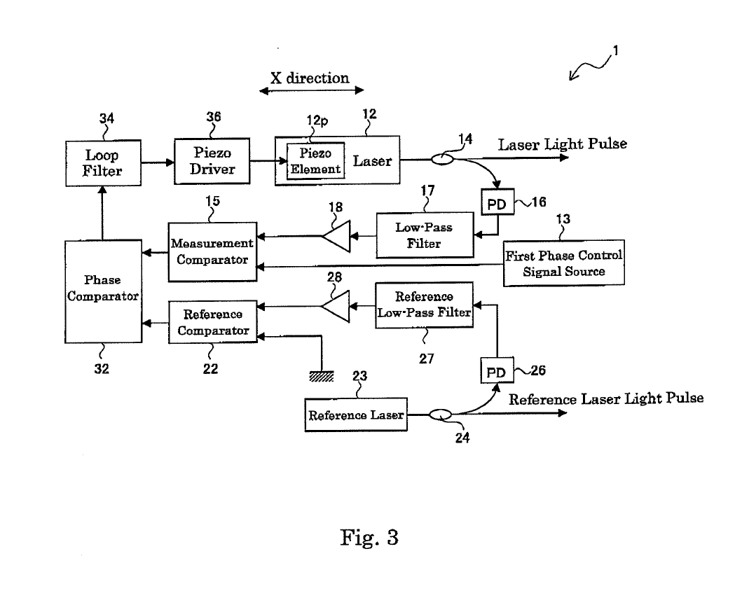

FIG. 3 is a functional block diagram showing a configuration of the phase control device for laser light pulse 1 according to the variation of the first embodiment of the present invention.

The phase control device for laser light pulse 1 according to the variation of the first embodiment includes the laser 12, the first phase control signal source 13, the optical coupler 14, the measurement comparator 15, the photodiode (photoelectric conversion unit) 16, the low-pass filter 17, the amplifier 18, the reference comparator 22, a reference laser 23, an optical coupler 24, a photodiode (reference photoelectric conversion unit) 26, a reference low-pass filter 27, an amplifier 28, the phase comparator (phase difference detector) 32, the loop filter 34, and the piezo driver 36.

The phase control device for laser light pulse 1 according to the variation of the first embodiment includes the reference laser 23, the optical coupler 24, the photodiode (reference photoelectric conversion unit) 26, the reference low-pass filter 27, and the amplifier 28 in place of the reference electric signal source 21 (refer to FIG. 1) according to the first embodiment. The other parts are the same as those of the first embodiment, and a description thereof, therefore, is omitted.

The reference laser 23 outputs a reference laser light pulse. The repetition frequency of the reference laser light pulse is equal to the frequency of the reference electric signal (50 MHz, for example).

The optical coupler 24 receives the reference laser light pulse output from the reference laser 23, and outputs the reference laser light pulse to the photodiode 26 and the outside at a ratio of 1:9 as a power ratio, for example. For example, the optical power of the reference laser light pulse fed to the photodiode 26 is 10% of the optical power of the reference laser light pulse output from the reference laser 23.

The photodiode (reference photoelectric conversion unit) 26 receives the reference laser light pulse from the optical coupler 24, and converts reference laser light pulse into an electric signal. The electric signal has a component of the frequency 50 MHz (component of the frequency of the reference electric signal), and a high-frequency component (frequency is much higher than 50 MHz).

The reference low-pass filter 27 removes the high-frequency component of the output from the photodiode 26. The cutoff frequency of the reference low-pass filter 27 is 70 MHz, for example. Thus, when the reference low-pass filter 27 receives the output from the photodiode 26, the high-frequency component is removed, and the component of the frequency 50 MHz passes.

The amplifier 28 amplifies the output from the reference low-pass filter 27. The output from the amplifier 28 becomes the reference electric signal.

It is conceivable to switch the reference low-pass filter 27 and the amplifier 28 with each other, and to feed the output from the photodiode 26 via the amplifier 28 to the reference low-pass filter 27. In this case, the reference electric signal is the output from the reference low-pass filter 27. In either case, the reference electric signal remains the signal based on the output from the reference low-pass filter 27.

### Second Embodiment

The phase control device for laser light pulse 1 according to a second embodiment is different from the phase control device for laser light pulse 1 according to the first embodiment in that the phase of the laser light pulse output from the laser 12 is controlled by changing the light intensity of the laser light pulse fed to the photodiode (photoelectric conversion unit) 16.

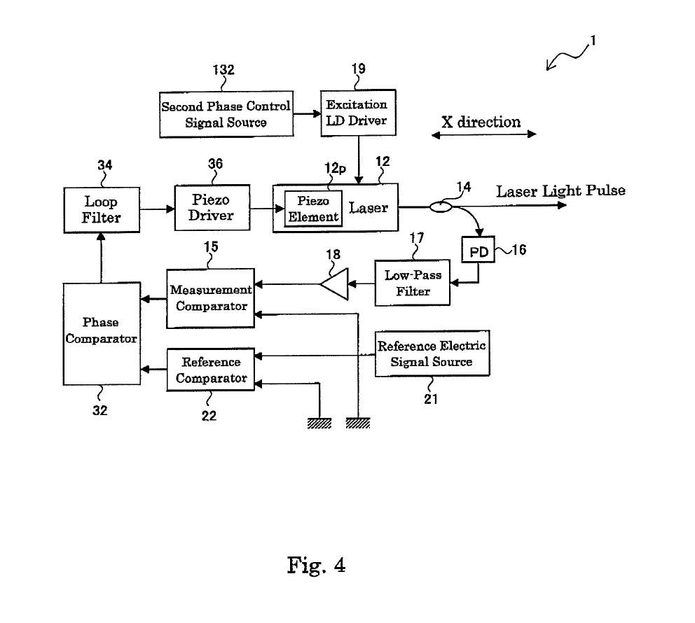

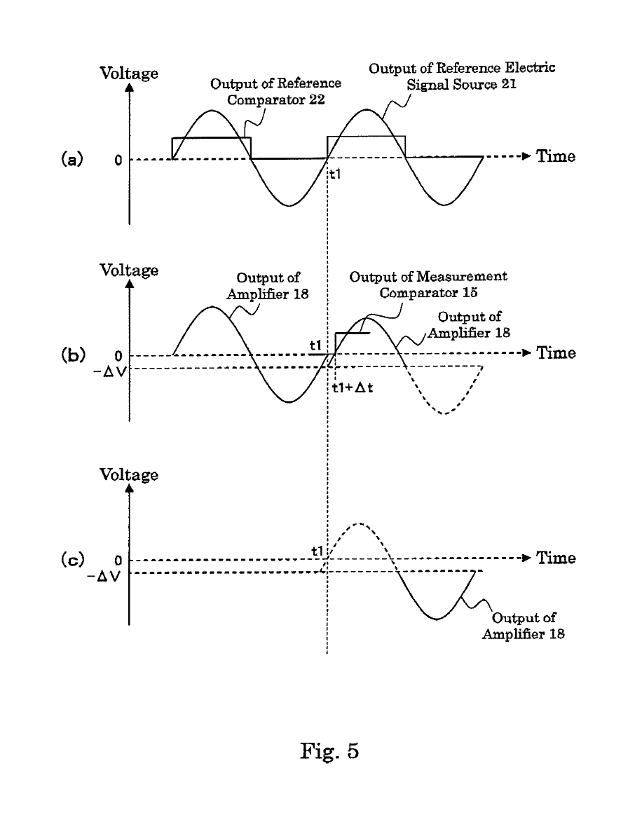

FIG. 4 is a functional block diagram showing a configuration of the phase control device for laser light pulse 1 according to the second embodiment of the present invention. FIG. 5 shows a waveform of an output voltage of the reference comparator 22 (FIG. 5(a)), a waveform of an output voltage of the measurement comparator 15 (before phase fluctuation) (FIG. 5(b)), and a waveform of an output voltage of the amplifier 18 (after phase fluctuation) (FIG. 5(c)) according to the second embodiment.

The phase control device for laser light pulse 1 according to the second embodiment includes the laser 12, a second phase control signal source 132, the optical coupler 14, the measurement comparator 15, the photodiode (photoelectric conversion unit) 16, the low-pass filter 17, the amplifier 18, an excitation LD driver 19, the reference electric signal source 21, the reference comparator 22, the phase comparator (phase difference detector) 32, the loop filter 34, and the piezo driver 36. In the following section, the same components are denoted by the same numerals as of the first embodiment, and will be explained in no more details.

The piezo element 12p, the optical coupler 14, the photodiode (photoelectric conversion unit) 16, the low-pass filter 17, the amplifier 18, the reference electric signal source 21, the reference comparator 22, the phase comparator (phase difference detector) 32, the loop filter 34, and the piezo driver 36 are the same as those of the first embodiment, and hence a description thereof is omitted.

The laser 12 includes the excitation LD (Laser Diode), which is not shown. The excitation LD is a laser diode outputting excitation light which excites the laser 12. The rest of the laser 12 is the same as that of the first embodiment, and a description thereof; therefore, is omitted.

The second phase control signal source 132 outputs the phase control signal, and feeds the phase control signal to the excitation LD driver 19. It should be noted that the second phase control signal source 132 is an arbitrary waveform generator, for example. The excitation LD driver 19 changes the power of the excitation light output from the excitation LD based on the phase control signal. As the power of the excitation light changes, the optical power of the laser light pulse changes, resulting in a change in the voltage of the measurement electric signal.

Out of the two input terminals of the measurement comparator 15, one is connected to the output (measurement electric signal) of the amplifier 18, and the other is grounded. The measurement comparator 15 compares the voltage of the measurement electric signal and the ground electric potential (=0[V]) with each other, thereby outputting a result thereof.

For example, referring to a neighborhood of the time t1+Δt in FIG. 5(b), if the voltage of the output from the amplifier 18 is greater than the ground electric potential (=0[V]), the voltage of the signal output from the measurement comparator 15 is a predetermined positive value. If the voltage of the output from the amplifier 18 is less than or equal to the ground electric potential (=0[V]), the voltage of the signal output from the measurement comparator 15 is 0[V].

A description will now be given of an operation of the second embodiment.

Referring to FIG. 5(a), the reference electric signal having the predetermined frequency (50 MHz, for example) is output from the reference electric signal source 21. Moreover, the comparison result between the voltage of the reference electric signal and the ground electric potential (=0[V]) is output from the reference comparator 22. As a result, the pulse having the repetition frequency 50 MHz is output from the reference comparator 22. On this occasion, it is assumed that the rise time of a certain pulse output from the reference comparator 22 is t1.

On this occasion, the average voltage of the output (measurement electric signal) from the amplifier 18 is set to 0[V] before the time t1. In this case, the operation of the phase control device for laser light pulse 1 is similar to that of an ordinary PLL circuit. In other words, the repetition frequency of the laser light pulse is 50 MHz (refer to the output from the amplifier 18 in FIG. 5(b)). The normal operation of the PLL circuit is as described in the first embodiment, and a description thereof, therefore, is omitted.

Moreover, the second phase control signal source 132 outputs the phase control signal, and feeds the phase control signal to the excitation LD driver 19 at the time t1 (refer to FIG. 5(b)). The excitation LD driver 19 changes the power of the excitation light output from the excitation LD based on the phase control signal. As the power of the excitation light changes, the optical power of the laser light pulse changes, resulting in a change in the voltage of the output (measurement electric signal) of the amplifier 18.

The last quarter period of the output from the amplifier 18 indicated by a dotted line in FIG. 5(b) shows that the output waveform of the amplifier 18 will actually be deviated from the position indicated by the dotted line when the time reaches the corresponding time which corresponds to the dotted line (which is the same as the first embodiment).

Referring to FIG. 5(b), it is assumed that the power of the excitation light is changed so that the average voltage of the output (measurement electric signal) from the amplifier 18 is −ΔV[V] on this occasion. It should be noted that the value of ΔV is the same as that of the first embodiment. Then, the rise time of the pulse output from the measurement comparator 15 is t1+Δt. It should be noted that the value of Δt is the same as that of the first embodiment. As a result, a difference between the rise time t1 of the pulse output from the reference comparator 22 and the rise time t1+Δt of the pulse output from the measurement comparator 15 is generated.

Control is provided so that the phase difference detected by the phase comparator 32 is zero degree in this case as well. In other words, the output waveform of the amplifier 18 is controlled to be shifted leftward by Δt so that the pulse output from the measurement comparator 15 is shifted leftward by Δt.

FIG. 5(c) shows the output waveform of the amplifier 18 when the output waveform of the amplifier 18 is shifted by Δt leftward. The first quarter period of the output from the amplifier 18 represented by a dotted line shows that the output waveform of the amplifier 18 has not completely been shifted at a time corresponding to the dotted line. In other words, the dotted line of the first quarter period of the output from the amplifier 18 is a virtual waveform obtained by extending, to the time t1−Δt, a waveform at a time when the output waveform of the amplifier 18 has completely shifted leftward by Δt.

Referring to FIGS. 5(b) and 5(c), it is appreciated that the phase of the output waveform of the amplifier 18 is shifted by Δt/T in a period approximately T/4 (it should be noted that T denotes the period of the output waveform of the amplifier 18). Therefore, it is appreciated that the phase of the laser light pulse shifts by Δt/T in a period approximately T/4.

According to the second embodiment, it is possible to control the phase of the laser light pulse output from the laser 12 without depending on a result of detection of a phase difference between light pulses output from two lasers.

The description is given while assuming that the average voltage of the output (measurement electric signal) of the amplifier 18 is changed by changing the power of the excitation light according to the second embodiment. However, the average voltage of the output (measurement electric signal) of the amplifier 18 can be changed by attenuating the laser light pulse and feeding the attenuated laser light pulse to the photodiode (photoelectric conversion unit) 16, which is described as a variation of the second embodiment.

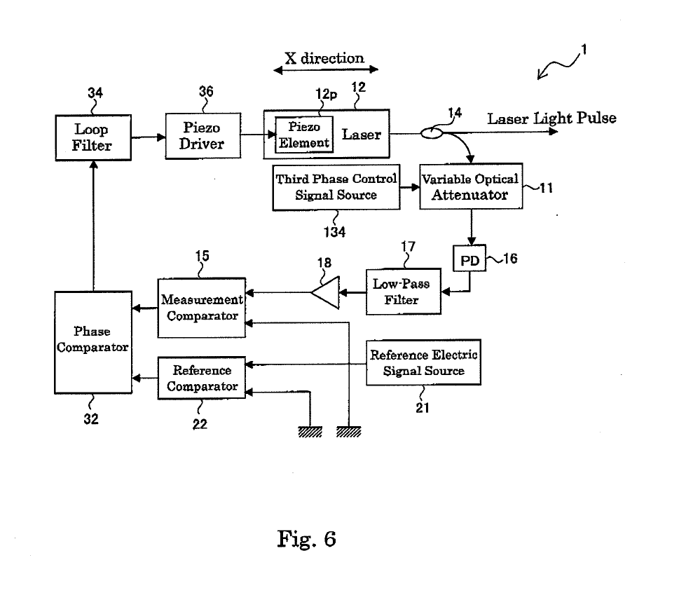

FIG. 6 is a functional block diagram showing a configuration of the phase control device for laser light pulse 1 according to the variation of the second embodiment of the present invention.

The phase control device for laser light pulse 1 according to the variation of the second embodiment includes, a variable optical attenuator 11, the laser 12, a third phase control signal source 134, the optical coupler 14, the measurement comparator 15, the photodiode (photoelectric conversion unit) 16, the low-pass filter 17, the amplifier 18, the reference electric signal source 21, the reference comparator 22, the phase comparator (phase difference detector) 32, the loop filter 34, and the piezo driver 36.

The phase control device for laser light pulse according to the variation of the second embodiment includes the third phase control signal source 134 and the variable optical attenuator 11 in place of the second phase control signal source 132 and the excitation LD driver 19. The other parts are the same as those of the second embodiment, and a description thereof, therefore, is omitted.

The third phase control signal source 134 outputs a phase control signal, and feeds the phase control signal to the variable optical attenuator 11. It should be noted that the third phase control signal source 134 is an arbitrary waveform generator, for example. The variable optical attenuator 11 receives the laser light pulse from the optical coupler 14, changes a degree of attenuating the light intensity of the laser light pulse based on the phase control signal (degree of attenuation is variable), and feeds the attenuated laser light pulse to the photodiode 16. As a result, the voltage of the measurement electric signal changes as well.

### Third Embodiment

The phase control device for laser light pulse 1 according to a third embodiment is obtained by changing one of the inputs to the measurement comparator 15 and one of the inputs to the reference comparator 22 of the phase control device for laser light pulse 1 according to the first embodiment.

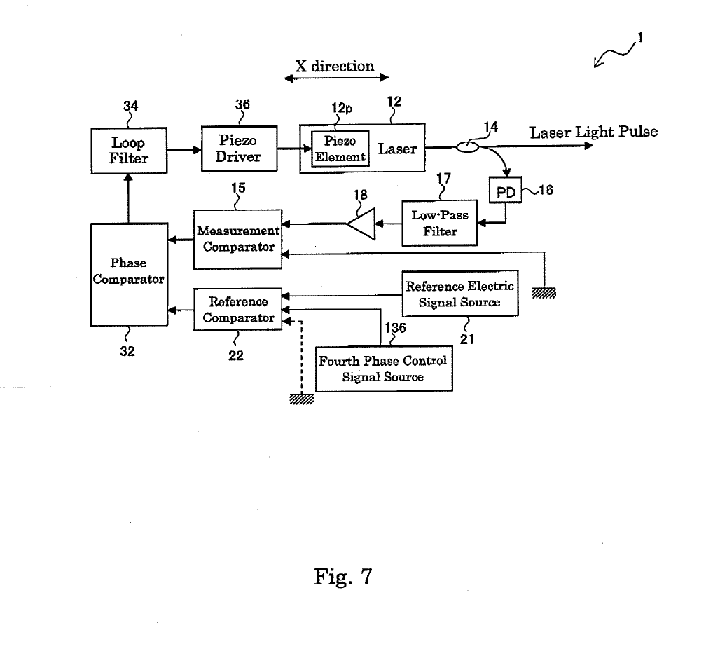

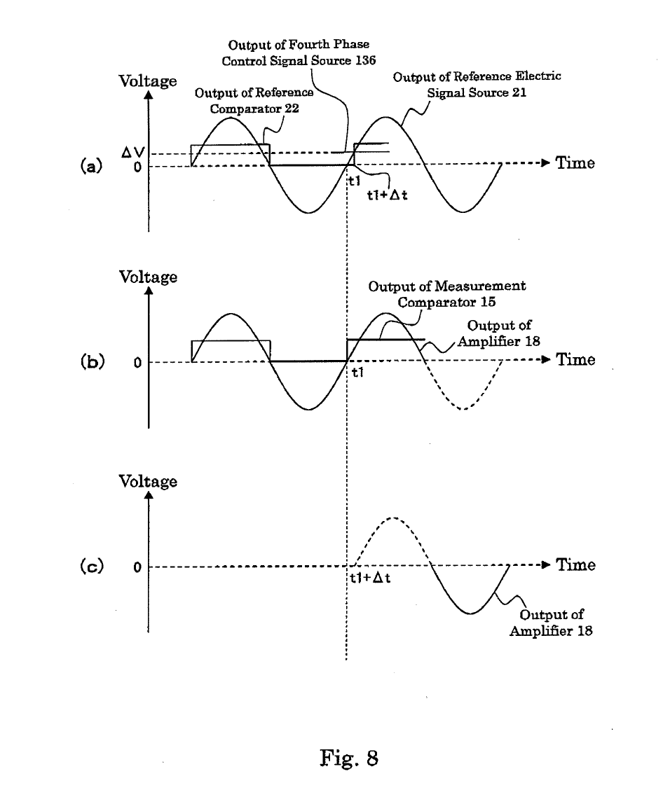

FIG. 7 is a functional block diagram showing a configuration of the phase control device for laser light pulse 1 according to the third embodiment of the present invention. FIG. 8 shows a waveform of an output voltage of the reference comparator 22 (FIG. 8(a)), a waveform of an output voltage of the measurement comparator 15 (before phase fluctuation) (FIG. 8(b)), and a waveform of an output voltage of the amplifier 18 (after phase fluctuation) (FIG. 8(c)) according to the third embodiment.

The phase control device for laser light pulse 1 according to the third embodiment includes the laser 12, a fourth phase control signal source 136, the optical coupler 14, the measurement comparator 15, the photodiode (photoelectric conversion unit) 16, the low-pass filter 17, the amplifier 18, the reference electric signal source 21, the reference comparator 22, the phase comparator (phase difference detector) 32, the loop filter 34, and the piezo driver 36. In the following section, the same components are denoted by the same numerals as of the first embodiment, and will be explained in no more details.

The laser 12, the piezo element 12p, the optical coupler 14, the photodiode (photoelectric conversion unit) 16, the low-pass filter 17, the amplifier 18, the reference electric signal source 21, the phase comparator (phase difference detector) 32, the loop filter 34, and the piezo driver 36 are the same as those of the first embodiment, and hence a description thereof is omitted.

The fourth phase control signal source 136 outputs the phase control signal. The voltage of the phase control signal is different from the predetermined voltage (ground electric potential). For example, referring to a neighborhood of a time t1+Δt in FIG. 8(a), the voltage ΔV of the phase control signal is different from the ground electric potential 0[V]. It should be noted that the fourth phase control signal source 136 is an arbitrary waveform generator, for example. For example, the phase control signal may have the voltage ΔV at the time t1+Δt, and a voltage 2 ΔV at a time t1+2 ΔV, . . . by causing the arbitrary waveform generator to generate the phase control signal. Moreover, though ΔV>0 in FIG. 8(a), ΔV<0 may hold. In this case, Δt<0.

The reference comparator 22 compares the voltage of the reference electric signal and the voltage of the phase control signal with each other, thereby outputting a result thereof. Referring to FIG. 7, out of two input terminals of the reference comparator 22, one is connected to the output from the reference electric signal source 21, and the other is connected to the output from the fourth phase control signal source 136. The signal output from the reference comparator 22 is determined according to the magnitude of the voltage input to the two input terminals of the reference comparator 22.

For example, referring to the neighborhood of the time t1+Δt in FIG. 8(a), if the voltage of the output from the reference electric signal source 21 is greater than the voltage ΔV of the output from the fourth phase control signal source 136, the voltage of the signal output from the reference comparator 22 is a predetermined positive value. If the voltage of the output from the reference electric signal source 21 is less than or equal to the voltage ΔV of the output from the fourth phase control signal source 136, the voltage of the signal output from the reference comparator 22 is 0[V].

The measurement comparator 15 compares the voltage of the measurement electric signal and a predetermined voltage with each other, thereby outputting a result thereof. It should be noted that the predetermined voltage is the ground electric potential, for example. In other words, the measurement comparator 15 compares the output voltage of the amplifier 18 and the ground electric potential (=0[V]) with each other, thereby outputting a result thereof.

For example, referring to FIG. 8(b), when the voltage of the output from the amplifier 18 is greater than the ground electric potential (=0[V]), the voltage of the signal output from the measurement comparator 15 is a predetermined positive value. If the voltage of the output from the amplifier 18 is less than or equal to the ground electric potential (=0[V]), the voltage of the signal output from the measurement comparator 15 is 0[V].

A description will now be given of an operation of the third embodiment.

Referring to FIG. 8(a), the reference electric signal having the predetermined frequency (50 MHz, for example) is output from the reference electric signal source 21. On this occasion, it is assumed that one input terminal of the reference comparator 22 is not connected to the output from the fourth phase control signal source 136, but is grounded (refer to a dotted arrow directing to the reference comparator 22 in FIG. 7) before the time t1+Δt. It should be noted that the other input terminal of the reference comparator 22 is connected to the reference electric signal source 21.

In this case, the operation of the phase control device for laser light pulse 1 is similar to that of an ordinary PLL circuit. In other words, the repetition frequency of the laser light pulse is 50 MHz (refer to the output from the amplifier 18 in FIG. 8(b)). The normal operation of the PLL circuit is as described in the first embodiment, and a description thereof, therefore, is omitted.

It should be noted that the frequency of the output from the amplifier 18 is 50 MHz. Moreover, a result of the comparison between the voltage of the output from the amplifier 18 and the ground electric potential (=0[V]) is output from the measurement comparator 15 referring to FIG. 8(b). As a result, the pulse having the repetition frequency 50 MHz is output from the measurement comparator 15. On this occasion, it is assumed that the rise time of a certain pulse output from the measurement comparator 15 is t1.

Further, referring to FIG. 8(a), it is assumed that the one input terminal of the reference comparator 22 is no longer grounded in the neighborhood of the time t1+Δt, and the phase control signal (voltage ΔV (>0[V])) output from the fourth phase control signal source 136 is fed to the one input terminal of the reference comparator 22. Then, the rise time of the pulse output from the reference comparator 22 is t1+Δt. As a result, a difference between the rise time t1 of the pulse output from the measurement comparator 15 and the rise time t1+Δt of the pulse output from the reference comparator 22 is generated.

Control is provided so that the phase difference detected by the phase comparator 32 is zero degree in this case as well. In other words, the output waveform of the amplifier 18 is controlled to be shifted rightward by Δt so that the pulse output from the measurement comparator 15 is shifted rightward by Δt.

FIG. 8(c) shows the output waveform of the amplifier 18 when the output waveform of the amplifier 18 is shifted by Δt rightward. The first quarter period of the output from the amplifier 18 represented by a dotted line shows that the output waveform of the amplifier 18 has not completely been shifted at a time corresponding to the dotted line. In other words, the dotted line of the first quarter period of the output from the amplifier 18 is a virtual waveform obtained by extending, to the time t1+Δt, a waveform at a time when the output waveform of the amplifier 18 has completely shifted rightward by Δt.

Referring to FIGS. 8(b) and 8(c), it is appreciated that the phase of the output waveform of the amplifier 18 is shifted by Δt/T in a period approximately T/4 (it should be noted that T denotes the period of the output waveform of the amplifier 18). Therefore, it is appreciated that the phase of the laser light pulse shifts by Δt/T in a period approximately T/4.

According to the third embodiment, it is possible to control the phase of the laser light pulse output from the laser 12 without depending on a result of detection of a phase difference between light pulses output from two lasers.

1. A phase control device for laser light pulse comprising:
a laser that outputs a laser light pulse;
a reference comparator that compares a voltage of a reference electric signal having a predetermined frequency and a predetermined voltage with each other, thereby outputting a result thereof;
a measurement comparator that compares a voltage based on a light intensity of the laser light pulse and a voltage of a measurement electric signal having the predetermined frequency, with a voltage of a phase control signal, thereby outputting a result thereof;
a phase difference detector that detects a phase difference between the output from the reference comparator and the output from the measurement comparator; and
a loop filter that removes a high frequency component of an output from the phase difference detector, wherein:
the voltage of the phase control signal is different from the predetermined voltage; and
the laser changes the phase of the laser light pulse according to the output from the loop filter.

2. The phase control device for laser light pulse according to claim 1, wherein the predetermined voltage is a ground electric potential.

3. The phase control device for laser light pulse according to claim 1, wherein a resonator length of the laser changes according to the output from the loop filter.

4. The phase control device for laser light pulse according to claim 3, wherein:
the laser comprises a piezo element;
the output from the loop filter is fed to the piezo element; and
the resonator length of the laser is changed by extension and contraction of the piezo element.

5. The phase control device for laser light pulse according to claim 1, comprising:
a photoelectric conversion unit that receives the laser light pulse; and
a low-pass filter that removes a high frequency component of the output from the photoelectric conversion unit,
wherein the measurement electric signal is based on the output from the low-pass filter.

6. The phase control device for laser light pulse according to claim 1, wherein the phase control signal is output from an arbitrary waveform generator.

7. The phase control device for laser light pulse according to claim 1, further comprising:
a reference laser that outputs a reference laser light pulse;
a reference photoelectric conversion unit that receives the reference laser light pulse; and
a reference low-pass filter that removes a high frequency component of the output from the reference photoelectric conversion unit,
wherein the reference electric signal is based on the output from the reference low-pass filter.

8. A phase control device for laser light pulse comprising:
a laser that outputs a laser light pulse;
a reference comparator that compares a voltage of a reference electric signal having a predetermined frequency and a predetermined voltage with each other, thereby outputting a result thereof;
a measurement comparator that compares a voltage based on a light intensity of the laser light pulse and a voltage of a measurement electric signal having the predetermined frequency, with the predetermined voltage, thereby outputting a result thereof;
a phase difference detector that detects a phase difference between the output from the reference comparator and the output from the measurement comparator;
a loop filter that removes a high frequency component of an output from the phase difference detector, wherein:
the voltage of the measurement electric signal is changed; and
the laser changes the phase of the laser light pulse according to the output from the loop filter.

9. The phase control device for laser light pulse according to claim 8, wherein the voltage of the measurement electric signal is changed by changing a power of excitation light exciting the laser.

10. The phase control device for laser light pulse according to claim 8, wherein:
the voltage of the measurement electric signal is changed by attenuating the laser light pulse; and
the degree of the attenuation is variable.

11. The phase control device for laser light pulse according to claim 8, wherein the predetermined voltage is a ground electric potential.

12. The phase control device for laser light pulse according to claim 8, wherein a resonator length of the laser changes according to the output from the loop filter.

13. The phase control device for laser light pulse according to claim 12, wherein:
the laser comprises a piezo element;
the output from the loop filter is fed to the piezo element; and
the resonator length of the laser is changed by extension and contraction of the piezo element.

14. The phase control device for laser light pulse according to claim 8, comprising:
a photoelectric conversion unit that receives the laser light pulse; and
a low-pass filter that removes a high frequency component of the output from the photoelectric conversion unit,
wherein the measurement electric signal is based on the output from the low-pass filter.

15. The phase control device for laser light pulse according to claim 8, wherein:
the voltage of the measurement electric signal changes based on a phase control signal; and
the phase control signal is output from an arbitrary waveform generator.

16. A phase control device for laser light pulse comprising:
a laser that outputs a laser light pulse;
a reference comparator that compares a voltage of a reference electric signal having a predetermined frequency and a voltage of a phase control signal with each other, thereby outputting a result thereof;
a measurement comparator that compares a voltage based on a light intensity of the laser light pulse and a voltage of a measurement electric signal having the predetermined frequency, with a predetermined voltage, thereby outputting a result thereof;
a phase difference detector that detects a phase difference between an output from the reference comparator and the output from the measurement comparator;
a loop filter that removes a high frequency component of an output from the phase difference detector, wherein:
the voltage of the phase control signal is different from the predetermined voltage; and
the laser changes the phase of the laser light pulse according to the output from the loop filter.

17. The phase control device for laser light pulse according to claim 16, wherein the predetermined voltage is a ground electric potential.

18. The phase control device for laser light pulse according to claim 16, wherein a resonator length of the laser changes according to the output from the loop filter.

19. The phase control device for laser light pulse according to claim 18, wherein:
the laser comprises a piezo element;
the output from the loop filter is fed to the piezo element; and
the resonator length of the laser is changed by extension and contraction of the piezo element.

20. The phase control device for laser light pulse according to claim 16, comprising:
a photoelectric conversion unit that receives the laser light pulse; and
a low-pass filter that removes a high frequency component of the output from the photoelectric conversion unit,
wherein the measurement electric signal is based on the output from the low-pass filter.

21. The phase control device for laser light pulse according to claim 16, wherein the phase control signal is output from an arbitrary waveform generator.
